(19) United States
(12) Patent Application Publication
(10) Pub. No.: US 2012/0000980 A1
(43) Pub. Date: Jan. 5, 2012

(54) CODE READING APPARATUS AND CODE READING METHOD

(75) Inventor: Kazufumi Suzuki, Shizuoka (JP)

(73) Assignee: TOSHIBA TEC KABUSHIKI KAISHA, Tokyo (JP)

(21) Appl. No.: 13/170,250

(22) Filed: Jun. 28, 2011

(30) Foreign Application Priority Data
Jul. 1, 2010 (JP) 2010-151393

(51) Int. Cl. G06K 7/14

(52) U.S. Cl. 235/454

(57) ABSTRACT

A code reading apparatus includes: a photographing section configured to photograph an image; a capturing section configured to capture the photographed image; a first reading section configured to detect, from the captured image, a code symbol that represents commodity information indicating a purchase target commodity and read, from the detected code symbol, the commodity information represented by the code symbol; a second reading section configured to continue, if a part of benefit indication that represents benefit information indicating a benefit granted for purchase of the commodity is detected from the captured image, after the part of the benefit indication is detected, the detection of the benefit indication from the image captured anew by the capturing section and read the benefit information represented by the detected benefit indication; and an output section configured to output the commodity information and the benefit information.

### CROSS-REFERENCE TO RELATED APPLICATIONS

This application is based upon and claims the benefit of priority from the prior Japanese Patent Application No. 2010-151393, filed on Jul. 1, 2010; the entire contents of which are incorporated herein by reference.

### FIELD

Embodiments described herein relate generally to a code reading apparatus and a code reading method.

### BACKGROUND

In the past, in order to reduce disposal losses of perishable foods, a retail store such as a supermarket often sells commodities at cut prices when the closing time approaches. In selling the commodities at cut prices, the store affixes price-cut or discount labels indicating price-cut amounts or discount rates to the commodities in order to clearly indicate to customers that the commodities are price-cut or discounted commodities.

When a price-cut or discount label is affixed to a commodity that a customer purchases, an operator of a POS (Point Of Sales) terminal reads a barcode of the commodity with a scanner. The operator inputs information concerning a price-cut or a discount from a keyboard, a touch panel, or the like. Therefore, if the operator does not notice a price-cut or discount label, it is likely that the operator sells a commodity, to which the price-cut or discount label is affixed, at a normal price.

On the other hand, JP-A-2008-33640 discloses a technique for automating price-cut or discount in a POS terminal by simultaneously photographing a barcode and a price-cut or discount label with a camera and outputting a commodity code and price-cut or discount information read from photographed images to the POS terminal.

Surfaces of commodities are various ranging from a flat surface to an uneven surface. Therefore, in the related art, there is a problem in that, if a price-cut or discount label is affixed to an uneven place of a commodity or affixed to a corner of the commodity, depending on an angle for photographing the price-cut or discount label, an image including the entire price-cut or discount label cannot be photographed and the price-cut or discounted commodity is sold at a normal price.

### DESCRIPTION OF THE DRAWINGS

FIG. 1 is a schematic perspective view of the configuration of a checkout lane system according to an embodiment;

FIG. 2 is a block diagram of the configuration of a code reading apparatus;

FIG. 3 is diagram of an example of a relation between a commodity and an imaging area of a camera;

FIG. 4 is a diagram of an example of a benefit indication label;

FIG. 5 is a diagram of another example of the benefit indication label;

FIG. 6 is a diagram for explaining a label characteristic table;

FIG. 7 is a diagram of image data in the imaging area imaged by the camera;

FIG. 8 is a diagram of an example of a relation between the commodity and the imaging area of the camera;

FIG. 9 is a diagram of image data included in an image area photographed by the camera;

FIG. 10 is a diagram for explaining barcode data;

FIG. 11 is a diagram for explaining a benefit code;

FIG. 12 is a diagram for explaining a composite code; and

FIG. 13 is a flowchart for explaining a procedure of information output processing performed by the code reading apparatus.

### DETAILED DESCRIPTION

In general, according to one embodiment, a code reading apparatus includes: a photographing section configured to photograph an image; a capturing section configured to capture the photographed image; a first reading section configured to detect, from the captured image, a code symbol that represents commodity information indicating a purchase target commodity and read, from the detected code symbol, the commodity information represented by the code symbol; a second reading section configured to continue, if apart of benefit indication that represents benefit information indicating a benefit granted for purchase of the commodity is detected from the captured image, after the part of the benefit indication is detected, the detection of the benefit indication from the image captured anew by the capturing section and read the benefit information represented by the detected benefit indication; and an output section configured to output the commodity information read by the first reading section and the benefit information read by the second reading section.

In general, according to another embodiment, a code reading method includes: capturing a photographed image; detecting, from the captured image, a code symbol that represents commodity information indicating a purchase target commodity and reading, from the detected code symbol, the commodity information represented by the code symbol; continuing, if a part of benefit indication that represents benefit information indicating a benefit granted for purchase of the commodity is detected from the captured image, after the part of the benefit indication is detected, the detection of the benefit indication from the image captured anew and reading the benefit information represented by the detected benefit indication; and outputting the read commodity information and the read benefit information.

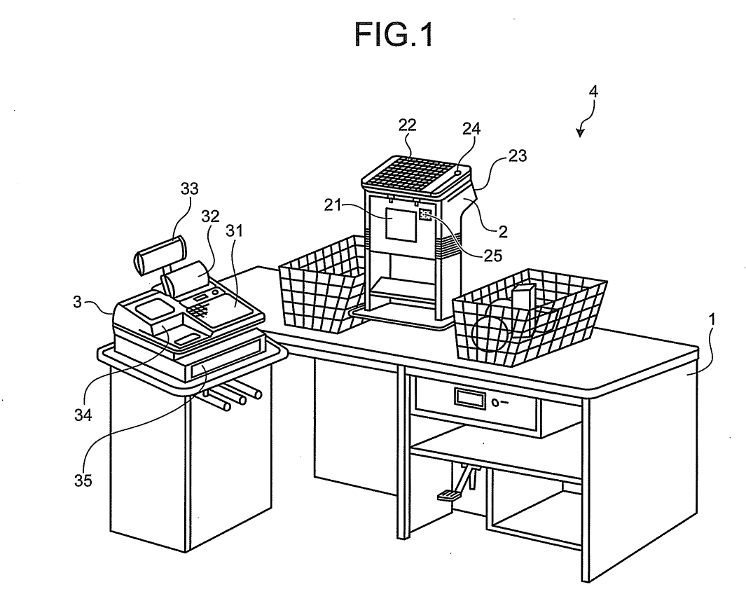

FIG. 1 is a schematic perspective view of the configuration of a checkout lane system according to an embodiment. As shown in FIG. 1, a checkout lane system 4 includes a sucker table 1 for placing a shopping basket including commodities, a code reading apparatus 2 vertically provided in substantially the center of the sucker table 1, and a POS terminal 3 connected to the code reading apparatus 2 by a not-shown transmission line to communicate with each other.

The POS terminal 3 performs sales registration for commodities to be purchased by a customer. As shown in FIG. 1, the POS terminal 3 includes a keyboard 31, an operator display device 32, a customer display device 33, a printer 34 configured to perform receipt printing and the like, and a drawer 35 for storing cash and the like. A closing key and the like necessary for settlement of commodity prices are disposed on the keyboard 31. The POS terminal 3 includes components and functions same as those of a POS terminal typically used in the checkout lane system of this type.

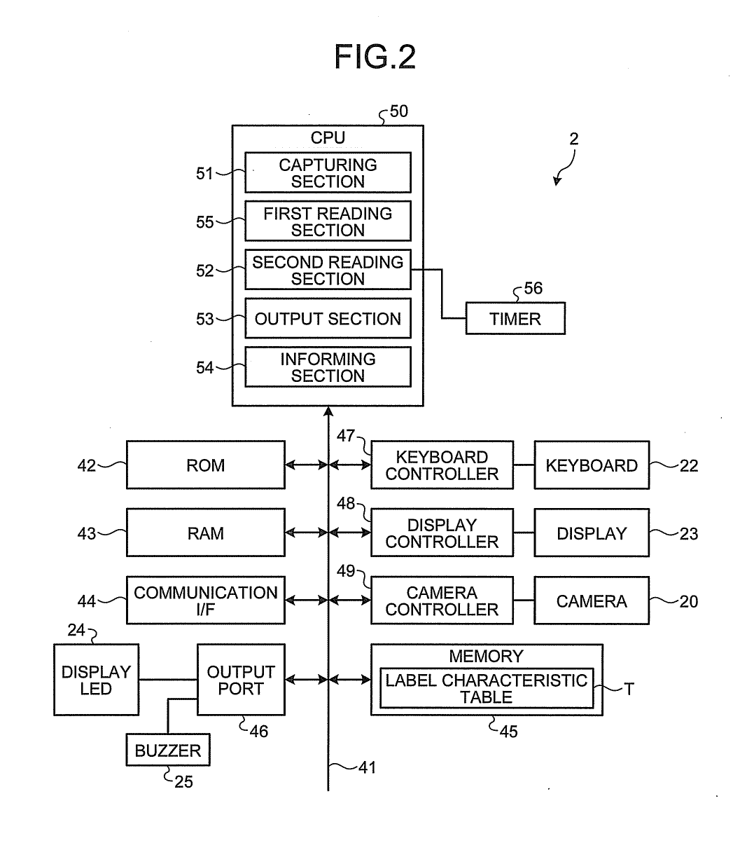

The code reading apparatus 2 reads a code symbol such as a barcode or a two-dimensional code affixed to a commodity and representing commodity information such as a commodity code indicating the commodity. The code reading apparatus 2 outputs the commodity information represented by the read code symbol to the POS terminal 3. As shown in FIG. 1, the code reading apparatus 2 mainly includes a reading window 21, a keyboard 22, a display 23, a display LED 24, and a buzzer 25. The keyboard 22 receives input by various keys when registration of a commodity that cannot be registered by a code symbol is performed. The display 23 displays names, prices, and the like of registered commodities to a customer. In order to inform an operator that a code symbol is read, the display LED 24 is turned on when a code symbol affixed to a commodity is read. In order to inform the operator that a code symbol affixed to a commodity is read, the buzzer 25 gives off buzzer sound. The code reading apparatus 2 incorporates a CCD (Charge Coupled Device) camera (hereinafter referred to as camera) 20 (see FIG. 2) on the inside of a place where the reading window 21 is provided.

FIG. 2 is a block diagram of the configuration of the code reading apparatus. The code reading apparatus 2 mainly includes a CPU (Central Processing Unit) 50, a ROM (Read Only Memory) 42, a RAM (Random Access Memory) 43, a communication I/F 44, an output port 46, a keyboard controller 47, a display controller 48, a camera controller 49, and a nonvolatile memory 45. In the code reading apparatus 2, the CPU 50, the ROM 42, the RAM 43, the communication I/F 44, the output port 46, the keyboard controller 47, the display controller 48, the camera controller 49, and the nonvolatile memory 45 are connected by a bus line 41 such as an address bus or a data bus.

The CPU 50 is a control section configured to control the entire operation of the code reading apparatus 2. The ROM 42 has stored therein a computer program according to this embodiment and other computer programs and the like for controlling the operation of the CPU 50. The RAM 43 is a work area used when the CUP 50 expands the various computer programs stored by the ROM 42. The RAM 43 stores various data such as image data imaged by the camera 20.

The communication I/F 44 controls data communication with the POS terminal 3 (see FIG. 1) connected to the code reading apparatus 2 via a bus. The output port 46 outputs driving signals to the buzzer 25 and the display LED 24. The keyboard controller 47 captures a key signal from the keyboard 22. The display controller 48 controls data display on the display 23. The camera controller 49 controls an imaging operation of the camera 20.

The camera 20 is a photographing section configured to image a code symbol such as a barcode or a two-dimensional code and benefit indication such as a price-cut label that represents benefit information indicating a benefit such as a price-cut, a discount, or point addition granted for purchase of a commodity.

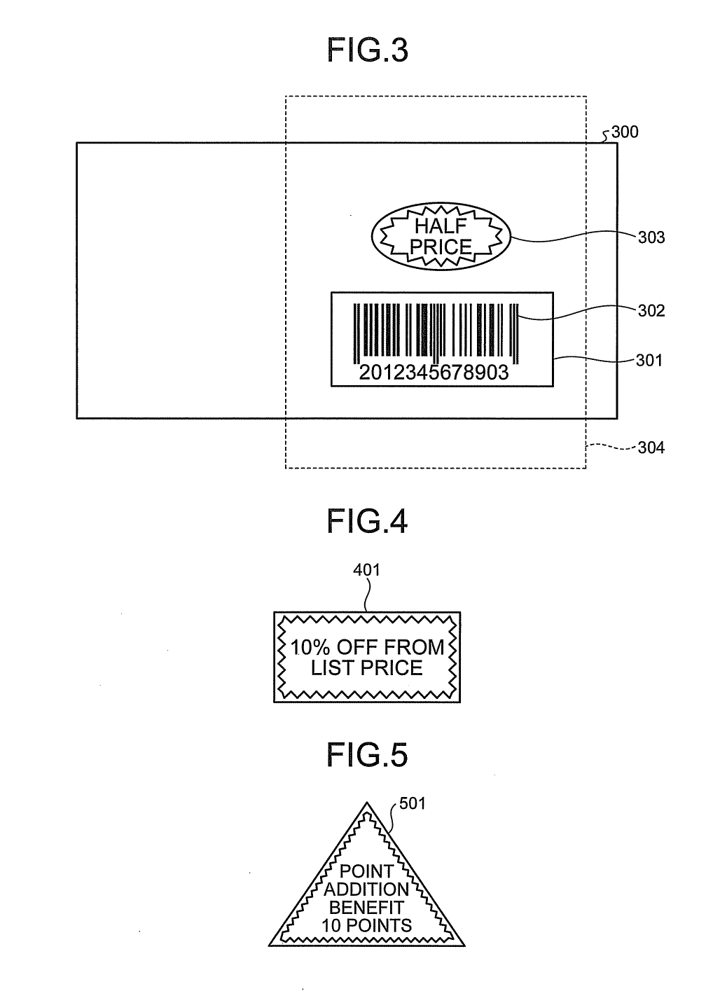

A relation between a commodity processed by the code reading apparatus 2 according to this embodiment and an imaging area of the camera 20 is explained. FIG. 3 is a diagram of an example of a relation between a commodity and an imaging area of the camera. An area surrounded by a dashed line in the figure is an imaging area 304, which is an area that the camera 20 can image in one frame. A store that sells a commodity 300 shown in FIG. 3 affixes, in addition to a barcode label 301, an elliptical price-cut label 303, which is an example of a benefit indication label, to the commodity 300.

The store that sells the commodity 300 affixes the barcode label 301, on which a barcode 302 or the like is displayed, to the commodity 300. As commodity information necessary for registering sales data of the commodity 300 in the POS terminal 3, the store that sells the commodity 300 incorporates information such as a commodity code in the barcode 302. The store that sells the commodity 300 displays, in a lower part of the barcode 302, a number representing a commodity code “2012345678903” incorporated in the barcode 302. Further, the store that sells the commodity 300 affixes, to the commodity 300, the price-cut label 303 that represents benefit information “half price” indicating a price-cut amount from a commodity price of the commodity 300.

Price-cut labels affixed to the commodity 300 are not limited to the price-cut label 303. The store that sells the commodity 300 may affix, to the commodity 300, a benefit indication label that represents benefit information indicating a benefit granted for the purchase of the commodity 300. FIGS. 4 and 5 are diagrams of other examples of the benefit indication label. The other examples of the benefit indication label include a rectangular discount label 401 representing a discount rate for the commodity 300 as shown in FIG. 4 and a triangular point addition label 501 representing the number of points granted to a customer who purchases the commodity 300 in addition to a normal number of granted points.

The nonvolatile memory 45 has stored therein a label characteristic table T that associates characteristics of benefit indication labels, which are benefit indication set in advance, and benefit information represented by the benefit indication labels, which are the benefit indication set in advance.

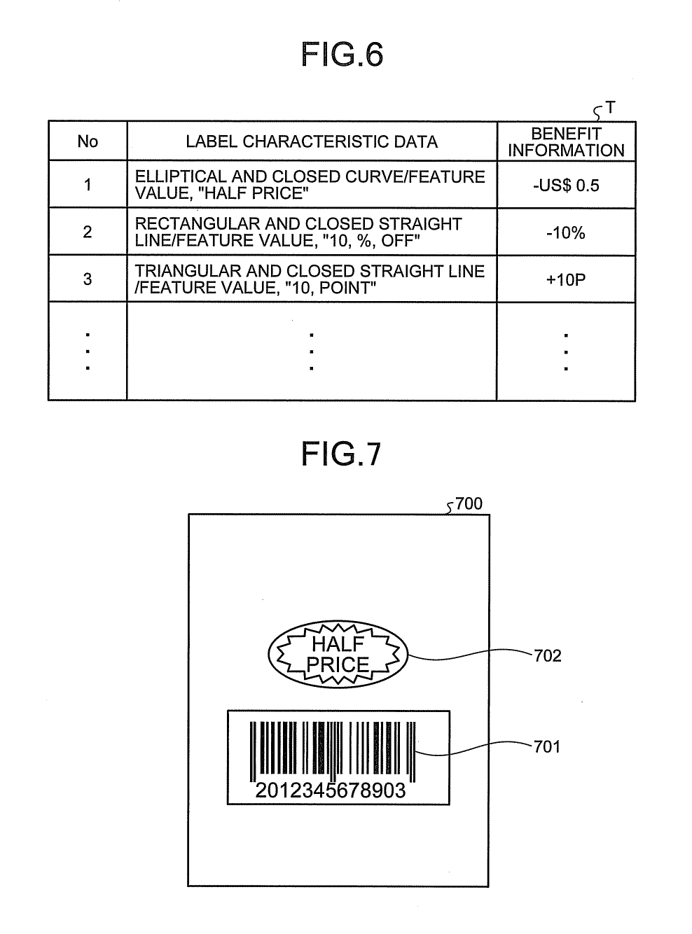

FIG. 6 is a diagram for explaining the label characteristic table. As shown in FIG. 6, the label characteristic table T stores, in association with each other, label characteristic data indicating characteristics of characters, pictures, and symbols included in benefit indication labels and benefit information represented by the benefit indication labels.

More specifically, the label characteristic data means information extracted from the benefit indication labels through character recognition by an OCR or the like. Specifically, the code reading apparatus 2 according to this embodiment extracts, as characteristics of the price-cut label 303, through character recognition, a feature value of an elliptical and closed curve and information “half price” as indicated by label characteristic data of No. 1 in the label characteristic table T shown in FIG. 6 from the price-cut label 303 described as “half price” in a closed ellipse shown in FIG. 3. Similarly, the code reading apparatus 2 according to this embodiment extracts, as characteristics of the discount label 401 and the point addition label 501, through character recognition, a feature value of a rectangular and closed straight line and information “10, %, off” and a feature value of a triangular and closed straight line and information “10, point” as indicated by label characteristic data of No. 2 and No. 3 shown in FIG. 6 from the discount label 401 and the point addition label 501 shown in FIGS. 4 and 5.

The benefit information is information indicating content of a benefit such as price-cut information or point grant information indicating content of a benefit granted for purchase of a commodity. In this embodiment, benefit information indicated by an alphanumerical value is used such that the benefit information can be used in sales registration by the POS terminal 3. As shown in FIG. 6, the label characteristic table T stores label characteristic data: the feature value of the elliptical and closed curve and “half price” and benefit information: “−US$0.5” indicating a price-cut of US$0.5 in association with each other. The label characteristic table T stores label characteristic data: the feature value of the rectangular and closed straight line and “10, %, off” and benefit information: “−10%” indicating a discount of 10% in association with each other. Further, the label characteristic table T stores label characteristic data: the feature value of the triangular and closed straight line and “10, point” and benefit information: “+10P” indicating point addition of 10 points in association with each other.

Characteristic functions of the code reading apparatus 2 according to this embodiment are explained below. The CPU 50 operates according to a computer program stored by the ROM 42 and expanded in the RAM 43 to function as a capturing section 51, a first reading section 55, a second reading section 52, an output section 53, and an informing section 54 as shown in FIG. 2.

The capturing section 51 outputs an imaging ON signal to the camera controller 49 in order to cause the camera controller 49 to start the imaging operation of the camera 20. The capturing section 51 captures image data included in the imaging area 304 imaged by the camera 20. Further, the capturing section 51 stores the captured image data in an image work area of the RAM 43.

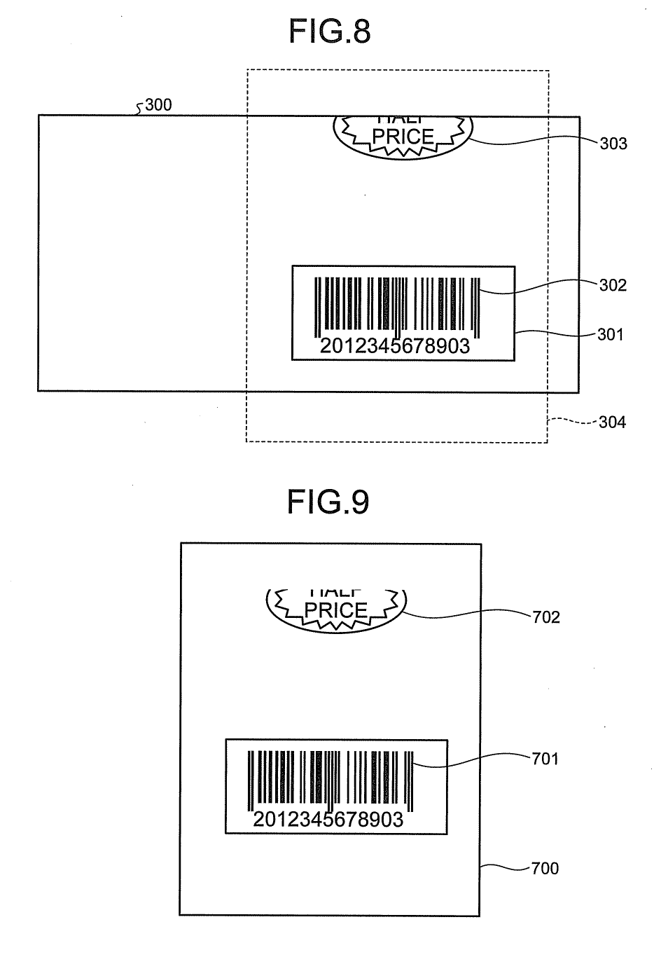

Image data 700 captured by the capturing section 51 is explained with reference to FIGS. 3 and 7 to 9. FIG. 7 is a diagram of image data in the imaging area imaged by the camera. FIG. 8 is a diagram of an example of a relation between a commodity and the imaging area of the camera. FIG. 9 is a diagram of image data included in an image area photographed by the camera.

If the barcode 302 and the price-cut label 303 are close to each other in the commodity 300 and the price-cut label 303 is affixed to a flat portion of the commodity 300 (e.g., the center of the commodity 300) as shown in FIG. 3, as shown in FIG. 7, the camera 20 images the image data 700 in the imaging area 304 in which an image 701 of the entire barcode 302 and an image 702 of the entire price-cut label 303 are fit. The capturing section 51 stores the image data 700 corresponding to the imaging area 304 in the image work area of the RAM 43.

On the other hand, if the barcode 302 and the price-cut label 303 are away from each other in the commodity 300 and the price-cut label 303 is affixed to an uneven portion of the commodity 300 (e.g., a corner of the commodity 300) as shown in FIG. 8, depending on a position where the operator holds the commodity 300 over the reading window 21, the camera 20 cannot image the image data 700 of the imaging area 304 in which the image 702 of the entire price-cut label 303 is fit (see FIG. 9). In this case, the operator changes the position of the commodity 300 held over the reading window 21 and the camera 20 photographs the commodity 300 plural times until the image 702 of the entire price-cut label 303 is fit in the imaging area 304. The capturing section 51 captures each of the image data 700 imaged plural times by the camera 20 and stores the image data 700 in the image work area of the RAM 43.

The first reading section 55 detects the image 701 of the barcode 302 from the image data 700 stored in the image work area of the RAM 43 by the capturing section 51. The first reading section 55 reads commodity information represented by the barcode 302 from the detected image 701 of the barcode 302.

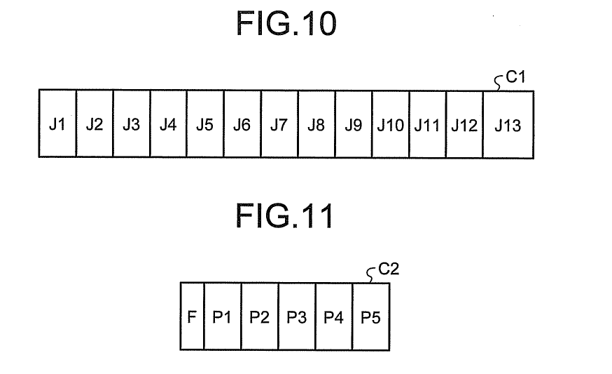

More specifically, the first reading section 55 binarizes the image data 700 of one frame stored in the image work area of the RAM 43. Subsequently, the first reading section 55 detects whether a data area concerning the barcode 302 is present in the binarized data. If the first reading section 55 detects the data area concerning the barcode 302 in the captured image data 700, the first reading section 55 decodes the barcode 302 and reads, as commodity information of the commodity 300, barcode data (a JAN code) C1 of J1 to J13 shown in FIG. 10. The barcode data C1 includes a manufacturer code, a commodity code as commodity information, and a check digit. The first reading section 55 stores the read barcode data C1 in a barcode work area of the RAM 43.

The second reading section 52 detects the image 702 of the price-cut label 303 from the image data 700 stored in the image work area of the RAM 43 by the capturing section 51. Subsequently, the second reading section 52 reads benefit information represented by the price-cut label 303 from the detected image 702 of the price-cut label 303. Further, if a part of the image 702 of the price-cut label 303 is detected, the second reading section 52 continues, for a predetermined time after the part of the image 702 of the price-cut label 303 is detected, the detection of the image 702 of the price-cut label 303 from the image data 700 capture anew by the capturing section 51. If the image 702 of the price-cut label 303 is detected within the predetermined time, the second reading section 52 reads benefit information represented by the price-cut label 303 from the detected image 702 of the price-cut label 303.

More specifically, the second reading section 52 applies character recognition by an OCR or the like to the image data 700 of one frame stored in the image work area of the RAM 43. The second reading section 52 collates characteristics of characters, pictures, symbols, or the like included in the image 702 of the price-cut label 303 and the label characteristic data (see FIG. 6) set in advance stored in the label characteristic table T. If label characteristic data having a high coinciding degree (e.g., label characteristic data having a coincidence degree equal to or higher than 90%) is detected, the second reading section 52 determines that the image 702 of the price-cut label 303 is detected from the image data 700.

The second reading section 52 collates characteristics of the image 702 of the price-cut label 303 and the label characteristic data of the label characteristic table T. If the second reading section 52 detects the image 702 of the price-cut label 303, a coincidence degree of which with the label characteristic data stored in the label characteristic table T reaches a predetermined value (e.g., the image 702 of the price-cut label 303, a coincidence degree of which with the label characteristic data stored in the label characteristic table T is 70% to 80%), the second reading section 52 determines that an image of a part of the price-cut label 303 is detected from the image data 700. For example, the second reading section 52 collates characteristics (characters and numbers in an unclosed ellipse) (see FIG. 9) of the image 702 of the price-cut label 303 and the label characteristic data (characters and numbers in an ellipse of a closed curve) stored in the label characteristic table T. If a coincidence degree between the characteristics of the image 702 of the price-cut label 303 and the label characteristic data stored in the label characteristic table T is 70%, the second reading section 52 determines that an image of a part of the price-cut label 303 is detected. The second reading section 52 continues, for a predetermined time after the image of the part of the price-cut label 303 is detected, the detection of the image 702 of the price-cut label 303 from the image data 700 captured anew by the capturing section 51.

The second reading section 52 reads, as benefit information represented by the detected image 702 of the price-cut label 303, the benefit information associated with the characteristics (label characteristic data) of the detected image 702 of the price-cut label 303 in the label characteristic table T. Subsequently, the second reading section 52 encodes the read benefit information, generates a benefit code C2 (see FIG. 11), and stores the benefit code C2 in a benefit code work area of the RAM 43.

FIG. 11 is a diagram for explaining a benefit code. As shown in FIG. 11, the benefit code C2 includes a flag F in which a type of a benefit is set and data P1 to P5 indicating values of benefits to be provided such as a price-cut amount, a discount rate, and the number of granted points. The flag F can represent, for example, the types of benefits as 1: discount rate, 2: price-cut amount, and 3: points.

Further, the second reading section 52 controls the operation of a timer 56 configured to measure the predetermined time after the image of the part of the price-cut label 303 is detected. If the image of the part of the price-cut label 303 is detected and the timer 56 does not time out, the second reading section 52 instructs the capturing section 51 to perform image capturing and causes the capturing section 51 to capture anew the image data 700 included in the imaging area 304 imaged by the camera 20.

In this way, if the image of the part of the price-cut label 303 is detected, the operator can image the commodity 300 with the camera 20 plural times for the predetermined time in which the timer 56 does not time out. Therefore, even if the price-cut label 303 is affixed to the corner of the commodity 300 and is not included in the image data 700 of the imaging area 304 as shown in FIG. 9, the operator can image the price-cut label 303 in the imaging area 304 including the price-cut label 303 and acquire the barcode data C1 and the benefit code C2.

In this embodiment, the second reading section 52 continues, for the predetermined time after the part of the image 702 of the price-cut label 303 is detected, the detection of the image 702 of the price-cut label 303 from the image data 700 captured anew by the capturing section 51. However, the second reading section 52 is not limited to this. The second reading section 52 only has to continue, after a part of the image 702 of the price-cut label 303 is detected, the detection of the image 702 of the price-cut label 303 from the image data 700 captured anew.

In this embodiment, if a part of at least one benefit indication label among plural benefit indication labels (images 702 of price-cut labels 303) is detected, the second reading section 52 may continue the detection of a benefit indication label from the image data 700 captured anew by the capturing section 51.

If the benefit code C2 generated by the second reading section 52 is stored in the RAM 43, the output section 53 combines the benefit code C2 with the barcode data C1 stored in the RAM 43 by the first reading section 55 to generate a composite code C3. The output section 53 outputs the generated composite code C3 to the POS terminal 3.

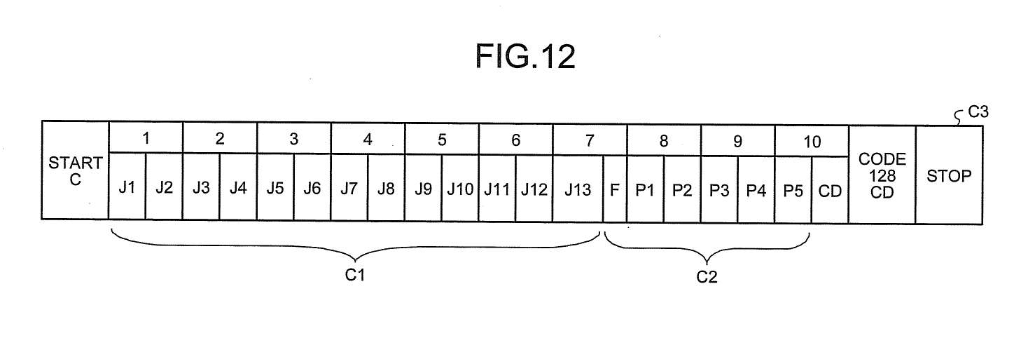

FIG. 12 is a diagram for explaining the composite code. As shown in FIG. 12, the composite code C3 begins with a start code and includes the barcode data C1, the benefit code C2, a check digit CD for the benefit code C2, and a check digit CODE128CD for the composite code C3. The composite code C3 ends with a stop code. The POS terminal 3 performs, on the basis of the composite code C3 received from the code reading apparatus 2, sales registration with the benefit indicated by the benefit code C2 granted for the purchase of the commodity 300.

As an example, if the price-cut label 303 for US$0.5 off is affixed to the commodity 300 as shown in FIG. 3, the benefit code C2 obtained by digitizing benefit information “−US$0.5” read by the second reading section 52 is generated. Therefore, the composite code C3 includes the barcode data C1 corresponding to the commodity code “2012345678903” and the benefit code C2 corresponding to “−US$0.5”. The POS terminal 3 reads a price of the commodity 300 corresponding to the barcode data C1 referring to a commodity master or the like stored by the POS terminal 3 or a host terminal (not shown) in the store. The POS terminal 3 cuts US$0.5 from the read price on the basis of the benefit code C2 and performs sales registration for the commodity 300.

If the first reading section 55 reads the barcode 302, the informing section 54 outputs a barcode ON signal in order to turn on the display LED 24 to inform the operator that the image 701 of the barcode 302 is detected. If the output section 53 outputs the composite code C3 or the barcode data C1 to the POS terminal 3, the informing section 54 outputs a barcode OFF signal in order to turn off the display LED 24 to inform the operator that the image 701 of the barcode 302 is not detected.

Further, if the second reading section 52 reads an image of a part of the price-cut label 303, in order to flash the display LED 24 to inform the operator of omission of reading of benefit information, the informing section 54 periodically outputs a barcode ON signal within a predetermined time after the image of the part of the price-cut label 303 is detected and until the image 702 of the price-cut label 303 is detected. In this embodiment, the informing section 54 flashes the display LED 24 to inform the operator of omission of reading of benefit information. However, the informing section 54 is not limited to this. For example, the informing section 54 may display, on a display section (not shown) on an operator side, a message indicating that benefit information cannot be read and inform the operator of omission of reading of the benefit information. Consequently, the operator can grasp that the image 702 of the entire price-cut label 303 cannot be imaged by the camera 20. Therefore, the operator can change an angle for imaging the price-cut label 303 and image the price-cut label 303 again.

If the output section 53 outputs the barcode data C1 to the POS terminal 3, the informing section 54 drives the buzzer 25 to give off first buzzer sound (e.g., “beep”) indicating that only the barcode label 301 is read and the price-cut label 303 is not read.

If the output section 53 outputs the composite data C3 to the POS terminal 3, the informing section 54 drives the buzzer 25 to give off second buzzer sound (e.g., “beep, beep”) indicating that both the barcode label 301 and the price-cut label 303 are read.

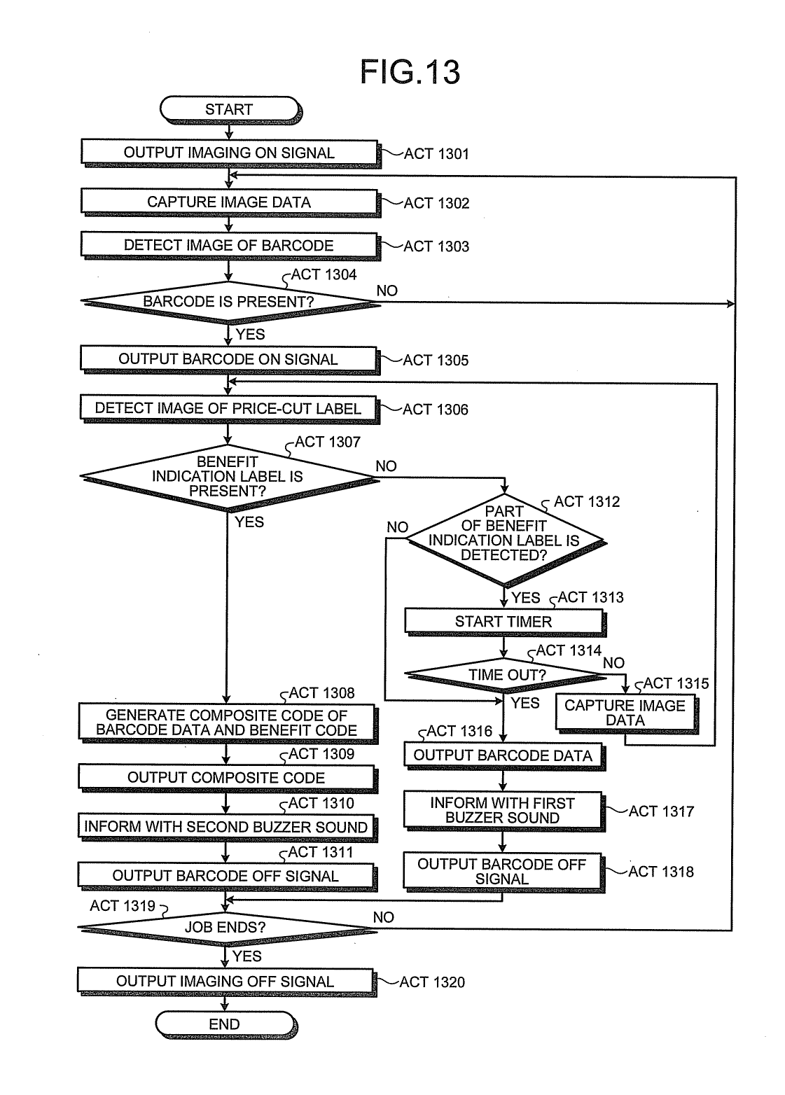

Information output processing for a commodity in the code reading apparatus 2 is explained below with reference to FIG. 13. FIG. 13 is a flowchart for explaining a procedure of the information output processing performed by the code reading apparatus.

If the start of a job is instructed by a command from the POS terminal 3, the CPU 50 of the code reading apparatus 2 starts information output processing. The capturing section 51 outputs an imaging ON signal to the camera controller 49 in order to start an imaging operation by the camera 20 (Act 1301). The capturing section 51 captures the image data 700 imaged by the camera 20 into the image work area of the RAM 43 (Act 1302). The first reading section 55 starts detection of the image 701 of the barcode 302 (Act 1303).

The first reading section 55 determines whether the image 701 of the barcode 302 is detected in Act 1303 (Act 1304). If the image 701 of the barcode 302 is not detected (No in Act 1304), the first reading section 55 continues the imaging by the camera 20 (Act 1302).

If the image 701 of the barcode 302 is detected (Yes in Act 1304), the informing section 54 outputs a barcode ON signal in order to turn on the display LED 24 to inform the operator that the image 701 of the barcode 302 is detected (Act 1305).

Subsequently, the second reading section 52 starts detection of the image 702 of the price-cut label 303 from the image data 700 captured into the image work area of the RAM 43 in Act 1302 (Act 1306). The second reading section 52 determines whether the image 702 of the price-cut label 303 (a benefit indication label) is detected in Act 1306 (Act 1307).

If the image 702 of the price-cut label 303 is detected (Yes in Act 1307), the output section 53 generates the composite code C3 (see FIG. 12) from the barcode data C1 stored in the barcode work area of the RAM 43 and the benefit code C2 stored in the benefit code work area (Act 1308). The output section 53 transmits and outputs the generated composite code C3 to the POS terminal 3 via the communication I/F 44 (Act 1309). The informing section 54 drives the buzzer 25 to give off the second buzzer sound (Act 1310). Further, the informing section 54 outputs a barcode OFF signal to turn off a display device such as an LED that informs the operator that a barcode is read (Act 1311).

Thereafter, the CPU 50 determines whether the end of the job is instructed by a command from the POS terminal 3 (Act 1319). If the end of the job is not instructed (No in Act 1319), the CPU 50 returns to Act 1302 and repeats Acts 1302 to 1319 until sales registration for all commodities is completed. If the end of the job is instructed (Yes in Act 1319), the CPU 50 outputs an imaging OFF signal to the camera controller 49 in order to end the imaging operation by the camera 20 (Act 1320).

On the other hand, if the image 702 of the price-cut label 303 is not detected (No in Act 1307), the second reading section 52 determines whether an image of a part of the price-cut label 303 is detected in Act 1306 (Act 1312). If the second reading section 52 determines that an image of a part of the price-cut label 303 is detected (Yes in Act 1312), the second reading section 52 starts the timer 56 configured to measure a predetermined time after the image of the part of the price-cut label 303 is detected (Act 1313). Further, if the second reading section 52 determines that an image of a part of the price-cut label 303 is detected (Yes in Act 1312), the informing section 54 may periodically output a barcode ON signal in order to flash the display LED 24 to inform the operator of omission of reading of benefit information. Subsequently, the second reading section 52 determines whether the timer 56 started in Act 1313 times out (Act 1314).

If the timer 56 does not time out (No in Act 1314), the second reading section 52 controls the capturing section 51 to capture the image data 700 anew (Act 1315). The second reading section 52 detects the image 702 of the price-cut label 303 from the image data captured anew (Act 1306).

If the timer 56 times out (Yes in Act 1314) and if an image of a part of the price-cut label 303 is not detected (No in Act 1312), the output section 53 transmits and outputs the barcode data C1 stored in the barcode work area of the RAM 43 to the POS terminal 3 via the communication I/F 44 (Act 1316). The informing section 54 drives the buzzer 25 to give off the first buzzer sound (Act 1317). The informing section 54 outputs a barcode OFF signal in order to turn off the display device such as the LED that informs the operator that the barcode 62 is read (Act 1318). Thereafter, the CPU 50 shifts to Act 1319.

As explained above, with the code reading apparatus 2 according to this embodiment, if an image of a part of a benefit indication label is detected, detection of an image of the benefit indication label is continued for a predetermined time after the image of the part of the benefit indication label is detected. Consequently, even if the benefit indication label is affixed to an uneven portion of the commodity 300 and an image of the entire benefit indication label cannot be detected, the barcode data C1 and the benefit code C2 can be acquired by imaging the commodity 300 plural times. Therefore, it is possible to automatically grant benefits such as price-cut processing and point addition processing without requiring price-cut processing by the operator.

With the code reading apparatus 2 according to this embodiment, if the second reading section 52 reads an image of a part of the price-cut label 303, the second reading section 52 informs the operator of omission of reading of benefit information. Consequently, the operator can grasp that the image 702 of the entire price-cut label 303 cannot be imaged by the camera 20. Therefore, it is possible to change an angle for imaging the price-cut label 303.

A computer program executed by the code reading apparatus according to this embodiment is provided while being incorporated in the ROM 42 or the like in advance. However, the computer program executed by the code reading apparatus 2 according to this embodiment may be provided while being recorded in a computer-readable recording medium such as a CR-ROM, a flexible disk (FD), a CD-R, or a DVD (Digital Versatile Disk) as a file of an installable format or an executable format.

Further, the computer program executed by the code reading apparatus 2 according to this embodiment may be stored on a computer connected to a network such as the Internet and provided by being downloaded through the network. The computer program executed by the code reading apparatus 2 according to this embodiment may be provided or distributed through the network such as the Internet.

Further effects and modifications can be easily derived by those skilled in the art. Therefore, wider aspects of the present invention are not limited to the specific details and the representative embodiment shown and described herein. Therefore, various changes are possible without departing from the spirit or the scope of the general concept of the invention defined by the appended claims and equivalents of the claims.

What is claimed is:

1. A code reading apparatus comprising:
a photographing section configured to photograph an image;
a capturing section configured to capture the photographed image;
a first reading section configured to detect, from the captured image, a code symbol that represents commodity information indicating a purchase target commodity and read, from the detected code symbol, the commodity information represented by the code symbol;
a second reading section configured to continue, if a part of benefit indication that represents benefit information indicating a benefit granted for purchase of the commodity is detected from the captured image, after the part of the benefit indication is detected, the detection of the benefit indication from the image captured anew by the capturing section and read the benefit information represented by the detected benefit indication; and
an output section configured to output the commodity information read by the first reading section and the benefit information read by the second reading section.

2. The apparatus according to claim 1, wherein, if a part of the benefit indication is detected from the captured image, the second reading section continues, for a predetermined time after the part of the benefit indication is detected, the detection of the benefit indication from the image captured anew by the capturing section.

3. The apparatus according to claim 1, wherein, if the benefit indication, a coincidence degree of which with characteristics of the benefit indication set in advance reaches a predetermined value, is detected from the captured image, the second reading section determines that a part of the benefit indication is detected.

4. The apparatus according to claim 1, further comprising a storing section configured to store characteristics of the benefit indication and the benefit information represented by the benefit indication in association with each other, wherein
if the benefit indication, a coincidence degree of which with the characteristics of the benefit indication stored in the storing section reaches a predetermined value, is detected from the captured image, the second reading section determines that a part of the benefit indication is detected, after the part of the benefit indication is detected, continues the detection of the benefit indication from the image captured anew by the capturing section, and reads, as the benefit information indicated by the detected benefit indication, the benefit information associated with the characteristics of the detected benefit indication in the storing section.

5. The apparatus according to claim 1, further comprising an informing section configured to inform an operator of omission of reading of the benefit information if a part of the benefit indication is detected.

6. The apparatus according to claim 5, wherein the informing section displays, on a display section, a message indicating that the benefit information cannot be read and informs the operator of the omission of the reading of the benefit information.

7. A code reading method comprising:
capturing a photographed image;
detecting, from the captured image, a code symbol that represents commodity information indicating a purchase target commodity and reading, from the detected code symbol, the commodity information represented by the code symbol;
continuing, if a part of benefit indication that represents benefit information indicating a benefit granted for purchase of the commodity is detected from the captured image, after the part of the benefit indication is detected, the detection of the benefit indication from the image captured anew and reading the benefit information represented by the detected benefit indication; and
outputting the read commodity information and the read benefit information.

8. The method according to claim 7, further comprising continuing, if a part of the benefit indication is detected from the captured image, for a predetermined time after the part of the benefit indication is detected, the detection of the benefit indication from the image captured anew.

9. The method according to claim 7, further comprising informing an operator of omission of reading of the benefit information if a part of the benefit indication is detected.

10. The method according to claim 9, further comprising displaying, on a display section, a message indicating that the benefit information cannot be read and informing the operator of the omission of the reading of the benefit information.
